(19) United States
(12) Patent Application Publication
(10) Pub. No.: US 2009/0051264 A1
(43) Pub. Date: Feb. 26, 2009

(54) FLUORESCENT LAMP TUBE

(76) Inventor: Onn Fah FOO, Hongkong (CN)

Correspondence Address: RABIN & Berdo, PC, 1101 14TH STREET, NW, SUITE 500, WASHINGTON, DC, 20005, US

(21) Appl. No.: 12/195,603

(22) Filed: Aug. 21, 2008

(30) Foreign Application Priority Data
Aug. 22, 2007 (CN) 200720128889.7

(51) Int. Cl. H01J 1/62

(52) U.S. Cl. 313/485

(57) ABSTRACT

The present invention relates to a new type of fluorescent lamp tube for illumination, comprising lamp filaments arranged respectively at both ends of the fluorescent lamp tube; tube end portions in which the lamp filaments are enclosed respectively; and a tube portion interconnecting the tube end portions and having a diameter smaller than that of the tube end portions. The present invention breaks through the prior art, such that the lamp tube can be devised to be more compact, whereby realizing a T1-type hot cathode fluorescent lamp.

### TECHNICAL FIELD

The present invention relates to a fluorescent lamp tube for illumination, and more particularly to a hot cathode fluorescent lamp tube of a small diameter.

### BACKGROUND OF THE INVENTION

A fluorescent lamp tube is a new, low pressure gas discharge type of electric light source, which is widely adapted for indoor and outdoor ambient lighting for various technical features it possessed, such as high in lighting efficiency, great in energy saving and color developing ability, and the like. Since its debut in early 90's of the last century, due to its excellent characteristics—such as small in size, simple in configuration, high in surface brightness, low in temperature rise, easy to process into various shapes and long in lifespan—the cold cathode fluorescent lamps have been quickly and widely adopted as backlights in various devices, such as scanners. A conventional fluorescent lamp used in our daily life is a low pressure hot cathode arc discharge lamp, wherein at both ends of which the electrodes are relatively hot; as a hot cathode fluorescent lamp, it is characterized by its high lighting efficiency. However, the existing hot cathode fluorescent lamp tubes are formed from glass tubes of uniform diameter and conventional lamp filaments, wherein the outer diameter of the lamp tubes are generally over 6.4 mm (T2-type). T1-type (with outer diameter around 3.2 mm) fluorescent lamp tubes cannot be realized with conventional manufacturing process as the lamp filaments cannot be adapted to it at the current engineering level, whereby one might only attempt to break through the issue by modifying the lamp tube of the fluorescent lamp.

### SUMMARY OF THE INVENTION

An object of the present invention is to overcome the above defects by providing a super compact T1-type fluorescent lamp tube employing the existing lamp filaments.

Accordingly, the technical solution of the present invention provided for the above object being a new type of fluorescent lamp tube, which comprises lamp filaments arranged respectively at both ends of the fluorescent lamp tube; tube end portions in which the lamp filaments are enclosed respectively; and a tube portion interconnecting the tube end portions and having a diameter smaller than that of the tube end portions.

According to an embodiment of the present invention, the tube end portion and the tube portion being connected via a connecting portion having a diameter gradually diminished from the tube end portion to the tube portion.

According to another embodiment of the present invention, the diameter of tube end portion equals to that of a conventional fluorescent lamp tube.

According to still another embodiment of the present invention, the diameter of the tube portion ranges from 2 mm to 12 mm.

According to yet still another embodiment of the present invention, the tube portion is in a form selected from a group consisting of linear type, U-type, Π-type, H-type, Buddha's Hand-type, W-type, SL-type, and spiral type of lamp tube.

Compared with the prior art, the advantageous effect of the present invention lies in that: via a connecting portion the tube end portion can directly connect with the tube portion, namely a T1-type fluorescent lamp tube. In this regard, the present invention surpasses the conventional technologies, and by means of which normal lamp filaments can be received thereinto and a super compact T1-type fluorescent lamp tube becomes possible, whereby a fluorescent lamp can be devised to be more compact, then the miniaturization of the fluorescent lamp is realized.

### BRIEF DESCRIPTION OF THE DRAWINGS

The present invention will be described in further details with reference to the accompany drawings.

FIG. 1 is a prospective view of the first embodiment of the present invention.

FIG. 2 is a prospective view of the second embodiment of the present invention.

FIG. 3 is a prospective view of the third embodiment of the present invention.

### DETAILED DESCRIPTION OF THE PREFERRED EMBODIMENTS

### Embodiment 1

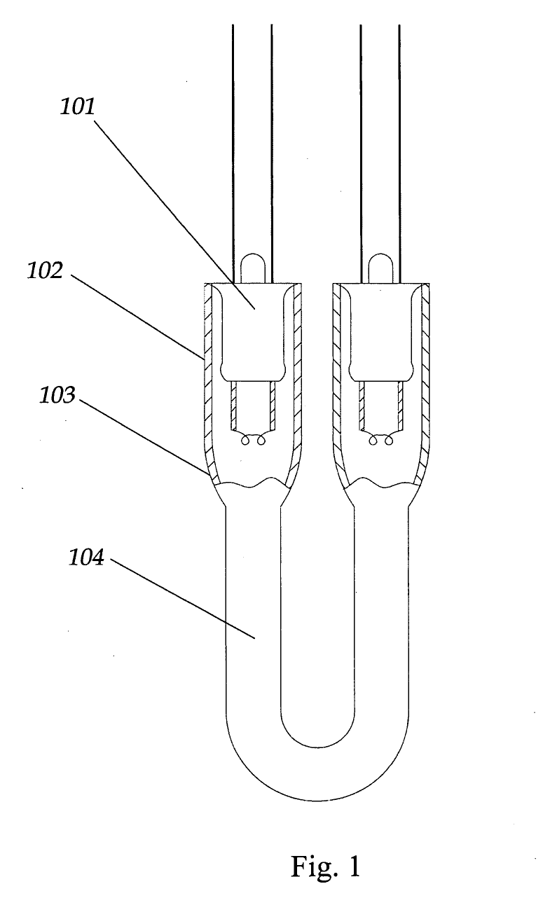

Referring to FIG. 1, a fluorescent lamp tube of the present invention comprises a tube end portion 102 in which a lamp filament 101 is enclosed, a U-type tube portion 104 connects with the tube end portion 102 via a connecting portion 103 which is gradually reduced from the tube end portion to the tube portion, wherein the diameter of the U-type tube portion 104 is in the range of 2-12 mm, and the diameter of the tube end portion 102 equals to that of a conventional fluorescent lamp tube and is greater than that of the U-type tube portion 104, while the value of the diameter might be determined as required. Wherein, the U-type tube portion 104 is substantially the luminescent component thereof, and both the tube end portion 102 and U-type tube portion 104 are formed from glass tubes.

### Embodiment 2

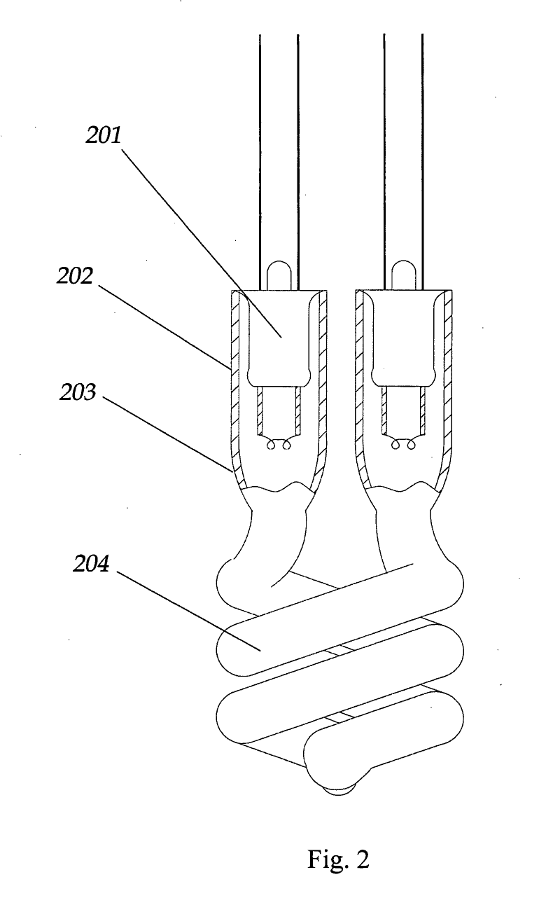

Referring to FIG. 2, a fluorescent lamp tube of the present invention comprises a tube end portion 202 in which a lamp filament 201 is enclosed, a spiral type tube portion 204 connects with the tube end portion 202 via a connecting portion 203 which is gradually reduced from the tube end portion to the tube portion, wherein the diameter of the spiral type tube portion 204 is in the range of 2-12 mm, while the diameter of the tube end portion 202 equals to that of a conventional fluorescent lamp tube and is greater than that of the spiral type tube portion 204, and the value of the diameter might be determined as required. Wherein the spiral type tube portion 204 is the actual luminescent portion, and both the tube end portion 202 and spiral type tube portion 204 are formed from glass tubes.

### Embodiment 3

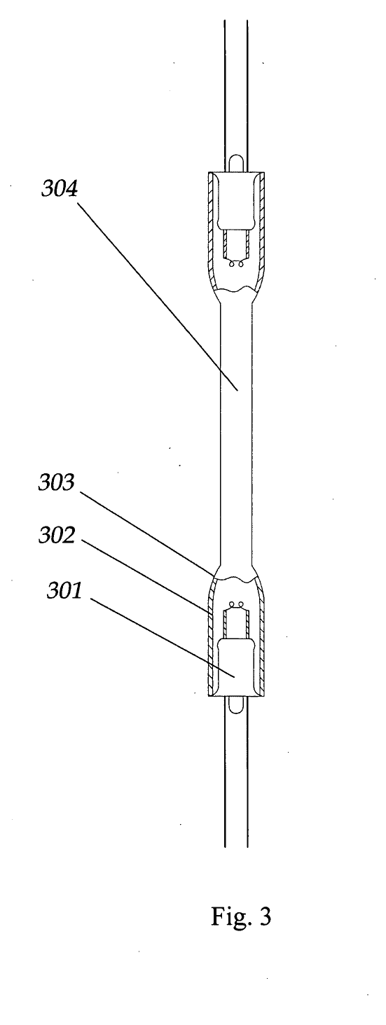

Referring to FIG. 3, a fluorescent lamp tube of the present invention comprises a tube end portion 302 in which a lamp filament 301 is enclosed, a linear type tube portion 304 connects with the tube end portion 302 via a connecting portion 303 which is gradually reduced from the tube end portion to the tube portion, wherein the diameter of the linear type tube portion 304 is in the range of 2-12 mm, while the diameter of the tube end portion 302 equals to that of a conventional fluorescent lamp tube and is greater than that of the linear type tube portion 304, and the value of the diameter might be determined as required. The linear type tube portion 304 is the luminescent portion, and the tube end portion 302 and linear type tube portion 304 both are formed from glass tubes.

It should be appreciated that the above embodiments are merely provided for illustrating but not limiting the design claimed by the present invention. The tube portion of the present invention might be in a form selected from a group consisting of linear type, U-type, Π-type, H-type, Buddha's Hand-type, W-type, SL-type, and spiral type of fluorescent lamp tube. With the fluorescent lamp tube of the present invention, the manufacturing of a super compact T1-type fluorescent lamp could be realized, and the fluorescent lamp could be devised and manufactured to be more compact.

Actually, the present invention can have other types of embodiments. The ordinary technical persons who have skills in the present field can make different types of corresponding amendments according to the basic inventive ideas of this application. However, the related changes or alternations in shapes would still fall within the protection scope of the application.

What is claimed is:

1. A new type of fluorescent lamp tube, comprising:
lamp filaments arranged respectively at both ends of the fluorescent lamp tube;
tube end portions in which the lamp filaments are enclosed respectively; and
a tube portion interconnecting the tube end portions and having a diameter smaller than that of the tube end portions.

2. A new type of fluorescent lamp tube as claimed by claim 1, wherein the tube end portion and the tube portion are connected via a connecting portion having a diameter gradually diminished from the tube end portion to the tube portion.

3. A new type of fluorescent lamp tube as claimed by claim 1, wherein the diameter of tube end portion equals to that of a conventional fluorescent lamp tube.

4. A new type of fluorescent lamp tube as claimed by claim 1, wherein the diameter of the tube portion is 2-12 mm.

5. A new type of fluorescent lamp tube as claimed by claim 1, wherein the tube portion is in a form selected from a group consisting of linear type, U-type, Π-type, H-type, Buddha's Hand-type, W-type, SL-type, and spiral type of lamp tube.

6. A new type of fluorescent lamp tube as claimed by claim 2, wherein the tube portion is in a form selected from a group consisting of linear type, U-type, Π-type, H-type, Buddha's Hand-type, W-type, SL-type, and spiral type of lamp tube.

7. A new type of fluorescent lamp tube as claimed by claim 3, wherein the tube portion is in a form selected from a group consisting of linear type, U-type, Π-type, H-type, Buddha's Hand-type, W-type, SL-type, and spiral type of lamp tube.

8. A new type of fluorescent lamp tube as claimed by claim 4, wherein the tube portion is in a form selected from a group consisting of linear type, U-type, Π-type, H-type, Buddha's Hand-type, W-type, SL-type, and spiral type of lamp tube.
